(19) United States
(12) Patent Application Publication
(10) Pub. No.: US 2012/0320863 A1
(43) Pub. Date: Dec. 20, 2012

(54) WIRELESS COMMUNICATION SYSTEM AND METHOD FOR RETRANSMISSION PROCESS THEREOF

(76) Inventors: Hyo Jin Lee, Suwon-si (KR); Joon Young Cho, Suwon-si (KR); Ju Ho Lee, Suwon-si (KR); Youn Sun Kim, Seongnam-si (KR); Jin Kyu Han, Dongjak-gu (KR)

(21) Appl. No.: 13/582,223

(22) PCT Filed: Apr. 5, 2011
(86) PCT No.: PCT/KR2011/002349

§ 371 Date: Aug. 31, 2012

(30) Foreign Application Priority Data
Apr. 9, 2010 (KR) 1020100032979
Apr. 28, 2010 (KR) 1020100039547

(51) Int. Cl. H04W 72/04

(52) U.S. Cl. 370/329

(57) ABSTRACT

The objective of the present invention is to control the HARQ process for two codewords assigned to each UE in downlink of the LTE-A system efficiently. In the proposed method, particularly when one of the two codewords is decoded successfully but the other is not in the HARQ process, the UE can be scheduled for both the retransmission and initial transmission by means of the control signal of PDCCH or ACK/NACK information of PHICHs. The proposed method is capable of reducing resource amount necessary for the control signal transmission without increasing the PDCCH decoding complexity of the UE.

### TECHNICAL FIELD

The present invention relates to an uplink multiple antenna system of an LTE-A system and, in particular, to new design for a Physical Downlink Control Channel (PDCCH) and operations of a base station and a terminal so as to efficiently perform scheduling of data retransmission for two codewords.

### BACKGROUND ART

Typically, a wireless communication system employs Forward Error Correction (FEC) and Automatic Repeat Request (ARQ) techniques to control transmission error. The FEC technique attempts to correct an error detected from received data and decodes correct data upon success in the error correction but, when the error correction has failed, wrong information may be provided to the user or the information may be missing. The ARQ technique transmits data using an FEC code having a high error detection capability, and when an error is detected from received data, the receive side requests the transmit side for data retransmission.

The FEC technique shows a relatively low efficiency in good channel environment and degrades the system reliability in case of error correction failure. In contrast, the ARQ technique guarantees high reliability and efficient transmission with low redundancy, but the wireless communication system efficiency is considerably degraded in a poor channel environment. In order to overcome the shortcomings, these two techniques are combined into a Hybrid ARQ (HARQ) in appropriated manner.

The HARQ technique is basically attempting error correction on the coded data received (hereinafter, referred to as “HARQ packet”) and determines whether to request for retransmission of the HARQ packet using simple error correction code such as Cyclic Redundancy Check (CRC). The receive side of the system supporting HARQ technique determines whether there is an error in the received HARQ packet and transmits an HARQ positive acknowledgement (hereinafter, referred to as “ACK”) or an HARQ negative acknowledgement (hereinafter, referred to as “NACK”) to a transmit side according to the determination result. The transmit side performs HARQ packet retransmission or initial HARQ packet transmission according to whether the received signal is HARQ ACK or HARQ NACK (hereinafter, referred to as “response signal”). Upon receipt of the HARQ packet, the receive side transmits the response signal using appropriated resource.

In the wireless communication system based on the Orthogonal Frequency Division Multiplexing (OFDM), such as 3GPP EUTRA (or LTE) or Advanced EUTRA (or LTE-A), the response signal is carried by a set of subcarriers, i.e., a response channel. Typically in a certain packet data transmission time interval (hereinafter, referred to as “TTI”), the packet data for multiple users are transmitted simultaneously such that the response channels for individual HARQ packets are transmitted at predefined timings after decoding of data received from the users scheduled in the TTI.

In LTE, the response channels of downlink data channels are transmitted on the physical channel resources assigned by an evolved Node B (eNB) to the User Equipments (UEs) received the data cannel in uplink respectively. Meanwhile, the response channels of uplink data channels are transmitted on the resource negotiated between the eNB and individual UEs for individual data packets after the eNB has received the data channels from the corresponding UE.

In LTE, Physical Hybrid-ARQ Indicator Channel (PHICH) is a physical channel for transmitting response signal to the uplink data. If an LTE UE has transmitted data in the nth TTI in uplink, it receives the PHICH in (n+4)th TTI. At this time, if the PHICH is received without separate control signal and carries NACK, the UE retransmits the data with predefined transmit parameters in (n+8)th TTI. If the UE has to use the parameters different from the predefined parameters for retransmission, the eNB has to transmit additional control signal.

The eNB transmits the parameters necessary for the UE to transmit the uplink data on the Physical Downlink Control Channel (PDCCH), and the UE must know the information about the PDCCH for uplink initial transmission. In the LTE system which does not support the Single User Multiple-Input Multiple-Output (SU-MIMO) mode in uplink, since only the single codeword transmission is possible, the Downlink Control Information (DCI) format 0 having a plurality of information fields as shown in table 1 is used in order to schedule the uplink transmission of the UEs.

In table 1, the Differentiation Flag (DF) field is used to differentiate the DCI format from other DCI format identical in length, the Hopping Flag (HF) field to indicate whether the UE uses frequency hopping, and the Resource Block Assignment (RBA) field to provide the information on the frequency resource to be used for uplink transmission. Here, N_{RB}^{UL} denote a number of Resource Blocks (RBs) to be used in uplink transmission. The Modulation and Coding Scheme (MCS) field is used to inform of the modulation and coding scheme to be used. The New Data Indicator (NDI) field is used to indicate if the grant is for a new transport block transmission. The Transmission Power Control (TPC) command field is used to control the transmit power. The Cyclic Shift Indicator (CSI) field is used to inform of Demodulation Reference Signal (DMRS). The Channel Quality Information Request (CQIR) field is used to indicate whether the eNB needs aperiodic CQI.

TABLE 1

| Field | Bits |
|---|---|
| Differentiation flag | 1 |
| Hopping flag | 1 |
| Resource block assignment | ┌log₂\|N_{RB}^{UL}\|N_{RB}^{UL} + 1\|/2\|┐ |
| Modulation and coding | 5 |
| scheme | |
| New data indicator | 1 |
| TPC command | 2 |
| Cyclic shift indicator | 3 |
| CQI request | 1 |

The LTE-A system introduced later supports the SU-MIMO mode in uplink. In the LTE-A system, up to two codewords can be transmitted. Accordingly, it is difficult to perform scheduling on both the two codewords only with the DCI format 0, and thus there is discussion on new DCI format design for scheduling two codewords in the LTE-A system. In the present invention, this new DCI format is referred to DCI format 0B, and this new format includes a plurality of information fields as shown in table 2. In table 2, Precoding Matrix Indicator (PMI) is used to indicate the precoder necessary for the SU-MIMO operation of the UE.

TABLE 2

| Field | Bits |
|---|---|
| Differentiation flag | 0 or 1 |
| Hopping flag | 0 or 1 |
| Resource block assignment | ┌log₂\|N_{RB}^{UL}\|N_{RB}^{UL} + 1\|/2\|┐ |
| Modulation and coding | 10 or less |
| scheme | |
| New data indicator | 1 or 2 |
| TPC command | 2 |
| Cyclic shift indicator | 3 |
| CQI request | 1 |
| Precoding matrix indicator | 3 or 6 |
| Etc. | 1 or 2 |

Suppose, in the LTE-A system, a situation where the UE transmits two codewords in SU-MIMO mode in uplink and the eNB decodes one of the codewords successfully but the other such that it is required to perform scheduling of a new initial transmission and retransmission of the decoding-failed codeword simultaneously. The simplest approach is to perform scheduling of both the initial transmission and retransmission with DCI format 0B. In the case of retransmission, however, it may cause resource waste to use the DCI format 0B for scheduling one initial transmission since there is no need of separate control signal in many cases as in the operations of the conventional LTE system. If the new DCI format is designed in simple way to overcome such a problem, it causes another problem in that the PDCCH decoding complexity increases.

### DISCLOSURE OF INVENTION

### Technical Problem

The present invention proposes a method for the system to control the HARQ process for two codewords when the LTE-A system assigns two codewords to a UE operating in SU-MIMO mode. The present invention proposes a method for scheduling the retransmission and initial transmission of a UE with the control signal or PDCCH or ACK/NACK information of the PHICHs especially when the decoding is successfully for the one of the two codewords but failed for the other. The proposed method is capable of reducing resource amount necessary for the control information without increase of PDCCH decoding complexity of the UE.

### Solution to Problem

In order to achieve the above the above objectives, the present invention proposes a new DCI format designed same as DCI format 0 in size and operations of the UE and eNB that are defined so as to perform scheduling of both the retransmission and initial transmission of the UE efficiently. The proposed method is capable of scheduling both the retransmission and initial transmission of a UE with a small number of control bits without increase of PDCCH decoding complexity of the UE.

In accordance with an aspect of the present invention, a retransmission control method of a base station in a wireless communication system is provided. The retransmission control method of the base station includes decoding two codewords received, determining, when one of the two codewords is decoded successfully but the other is not, scheduling information for initial transmission corresponding to the successfully decoded codeword and retransmission corresponding to the failed codeword, and transmitting control information generated according to a DCI format having a retransmission indicator for requesting for retransmission.

In accordance with another aspect of the present invention, a retransmission control method of a terminal in a wireless communication system is provided. The retransmission control method of the terminal includes determining, when a control signal is received in a DCI format, whether the control signal is a response to two codewords, determining, when the control signal is a response to two codewords, whether the DCI format includes a retransmission indicator, and performing, when the DCI format includes a retransmission indicator, initial transmission corresponding to one of the tow codewords and retransmission corresponding to the other.

In accordance with another aspect of the present invention, a receiver of a base station in a wireless communication system is provided. The receiver of the base station includes a decoder which decodes two codewords received, and a control signal generator which determining, when one of the two codewords is decoded successfully but the other is not, scheduling information for initial transmission corresponding to the successfully decoded codeword and retransmission corresponding to the failed codeword and transmits control information generated according to a DCI format having a retransmission indicator for requesting for retransmission.

In accordance with another aspect of the present invention, a transmitter of a terminal in a wireless communication system is provided. The transmitter of the terminal includes a control signal detector which determines, when a control signal is received in a DCI format, whether the control signal is a response to two codewords and determines, when the control signal is a response to two codewords, whether the DCI format includes a retransmission indicator, and a retransmission controller which performs, when the DCI format includes a retransmission indicator, initial transmission corresponding to one of the tow codewords and retransmission corresponding to the other.

### Advantageous Effects of Invention

In downlink of the LTE-A system in which two codewords are assigned to a UE using multiple antennas, when one of the two codewords is decoded successfully but the other is not, the present invention is capable of scheduling both the retransmission and initial transmission of the UE simultaneously with a small number of bits without increase of PDCCH decoding complexity. That is, the present invention is advantageous to reduce both the PDCCH decoding complexity in HARQ process and resource amount necessary for control signal transmission simultaneously.

### BRIEF DESCRIPTION OF DRAWINGS

The objects, features and advantages of the present invention will be more apparent from the following detailed description in conjunction with the accompanying drawings, in which:

FIG. 1 is a diagram illustrating a configuration of the transmitter of a UE according to the embodiments of the present invention;

FIG. 2 is a diagram illustrating a configuration of the receiver of an eNB according to the embodiments of the present invention;

FIGS. 3A and 3B are flowcharts illustrating operations of the eNB according to the first embodiment of the present invention;

FIG. 4 is a flowchart illustrating operations of the UE according to the first embodiment of the present invention;

FIGS. 5A and 5B are flowcharts illustrating operations of the eNB according to the second embodiment of the present invention;

FIG. 6 is a flowchart illustrating operations of the UE according to the second embodiment of the present invention;

FIGS. 7A and 7B are flowcharts illustrating operations of the eNB according to the third embodiment of the present invention; and

FIG. 8 is a flowchart illustrating operations of the UE according to the third embodiment of the present invention.

### MODE FOR THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Although the description is directed to the wireless communication system based on OFDM (Orthogonal Frequency Division Multiplexing), especially the LTE or LTE-A system, the subject matter of the present invention can be applied to other communication systems having similar technical background and channel types without departing from the scope of the present invention, and this is obvious to those skilled in the art.

The present invention relates to a method for controlling the HARQ process using two codewords, e.g., CW#0 and CW#1, for PUSCH transmission of a UE with multiple antennas in LTE-A system.

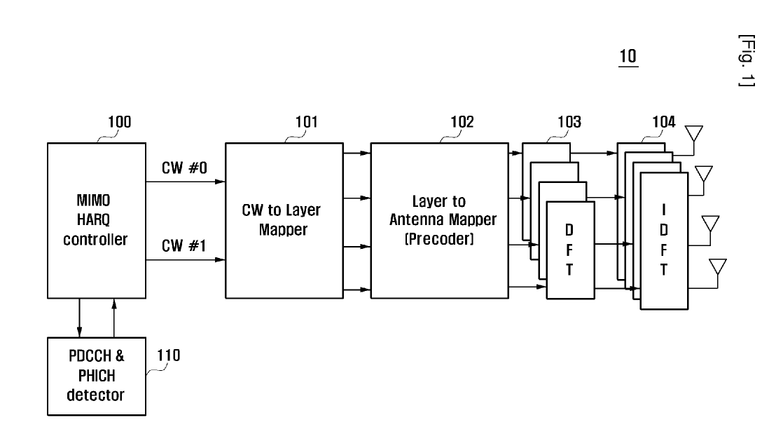

FIG. 1 is a diagram illustrating a configuration of the transmitter of a UE according to the embodiments of the present invention.

As shown in FIG. 1, the UE 10 includes a control signal detector (PDCCH & PHICH detector) 110, an HARQ controller (MIMO HARQ controller) 100, a codeword mapper (CW to Layer Mapper) 101, a precoder (Layer to Antenna Mapper) 102, a Discrete Fourier Transformer (DFT) 103, and an Inverse DFT (IDFT) 104.

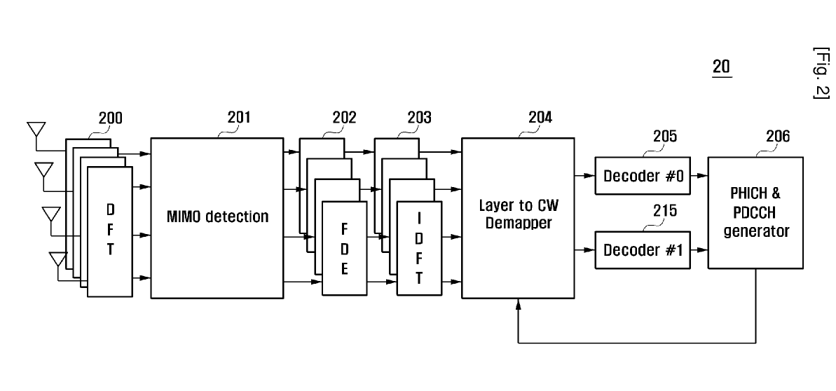

The control signal detector 110 receives PDCCH or PHICH of the eNB 20 (see FIG. 2) and extracts control information. The HARQ controller 100 modulates the codewords, e.g. CW#0 and CW#1, assigned for an initial transmission or retransmission according to the extracted information. The codeword mapper 101 maps the codewords to layers. The precoder 102 performs precoding to map the codewords to multiple transmit antennas. The DFT 103 performs Discrete Fourier Transform on the codewords, and the IDFT 104 performs inverse Discrete Fourier Transform on the codewords to transmit through the multiple transmit antennas.

In the UE 10 according to an embodiment of the present invention, the control signal detector 110 receives a control signal in a DCI format and determines whether the control signal is a response to the two codewords. If the control signal is a response to the two codewords, the control signal detector 110 determines whether the DCI format includes a retransmission indicator. If the DCI format includes a retransmission indicator, the control signal detector 110 further determines whether a codeword indicator for identifying the codeword for the initial transmission among the two codewords in the DCI format. If the DCI format includes the retransmission indicator is included, the control signal detector 110 can extract the NACK or ACK signal per codeword from the PHICH.

In the UE 10 according to the embodiments of the present invention, if the DCI format includes the retransmission indicator, the HARQ controller 100 performs initial transmission corresponding to one of the two codewords and retransmission corresponding to the other. At this time, the HARQ controller 100 can determine and perform retransmission per codeword according to the codeword indicator in the DCI format. The HARQ controller 100 can determine and perform retransmission per codeword according to the NACK signal of PHICH.

FIG. 2 is a diagram illustrating a configuration of the receiver of an eNB according to the embodiments of the present invention.

Referring to FIG. 2, the eNB 20 includes a DFT (DFT performer) 200, a MIMO detector (MIMO detection performer) 201, a Frequency Domain Equalization performer (FDE) 202, an IDFT (IDFT performer) 203, a CW demapper (Layer to CW Demapper) 204, decoders (Decoder#0 and Decoder#1) 205 and 215, and a control signal generator (PHICH & PDCCH generator) 206.

The DFT 200 performs DFT on the signal received through multiple antennas. The MIMO detector 201 detects the signal, and the FDE 202 performs equalization on the signal in frequency domain. The IDFT 203 performs Inverse Discrete Fourier Transformation on the signal. The CW demapper 204 performs layer-demapping on the signal. At this time, the CW demapper 204 determines the codewords, e.g. CW#0 and CW#1, from the signal. The decoders 205 and 215 decode the data and checks whether the decoded data has an error. The decoders 205 and 215 determine whether the codewords are decoded successfully. At this time, the decoders 205 and 215 checks the response signal, i.e. ACK/NACK information, corresponding to the data received from 20 according to whether each of the codewords is decoded successfully. The control signal generator 206 generates PDCCH or PDCCH carrying the control signal necessary at the UE according to the decoding result.

In the eNB according to the embodiments, when one of the codewords is decoded successfully but the other is failed to decode, the control signal generator 206 determines the scheduling information for the initial transmission corresponding to the successfully decoded codeword and the retransmission of the codeword of which initial transmission has failed. The control signal generator 206 also generates a control signal according to the DCI format having the retransmission indicator for retransmission request and transmits the control signal to the UE 10. At this time, the control signal generator 206 can add a codeword indicator for identifying the successfully decoded codeword to the DCI format to be transmitted. The control signal generator 206 also can transmit the PHICH including the NACK signal corresponding to the decoding-failed codeword and the ACK signal corresponding to the successfully decoded codeword along with the control signal.

In the present invention, the description is directed to a case where only one of the two codewords is successfully decoded.

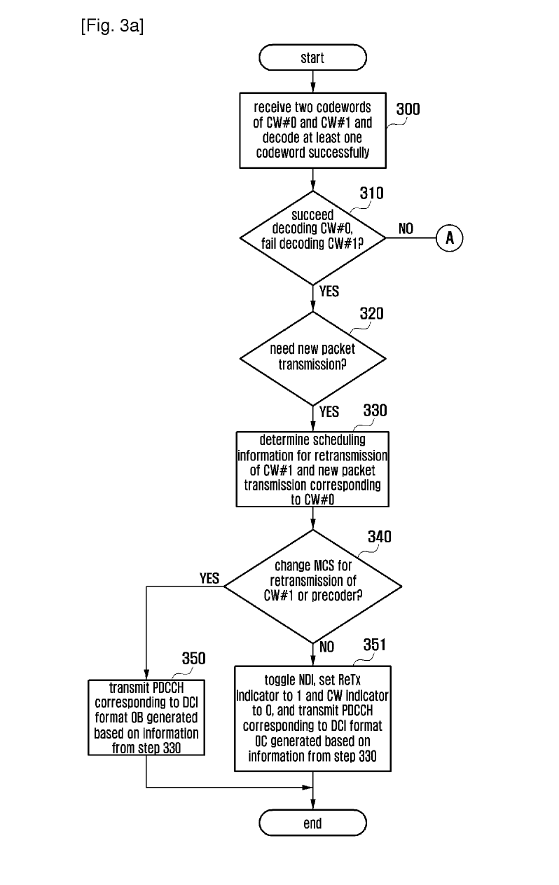

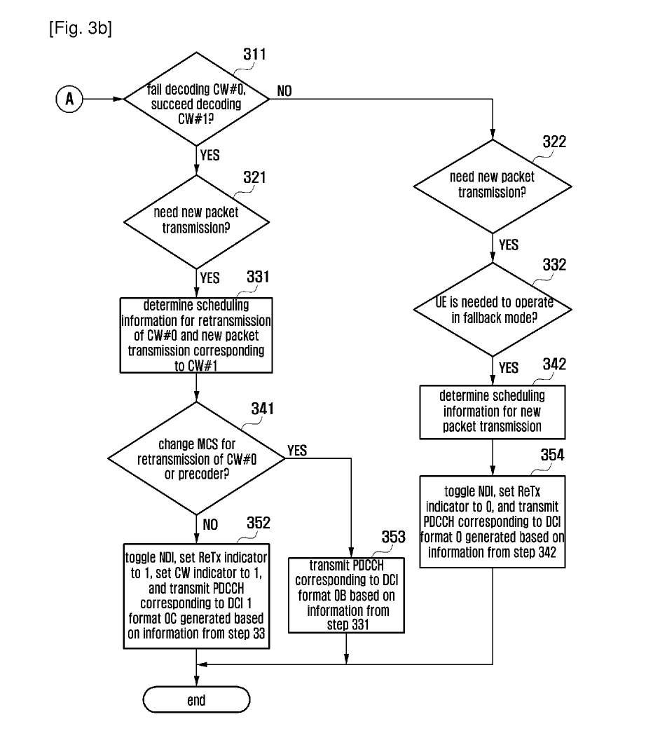

FIGS. 3A and 3B are flowcharts illustrating operations of the eNB according to the first embodiment of the present invention.

In this embodiment depicted in FIGS. 3A and 3B, the eNB 20 first decodes at least one of the two codewords, i.e. CW#0 and CW#1, received from the UE 10 successfully (300). Next, the eNB 20 determines which codeword is decoded successfully among the CW#0 and CW#1 (310 and 311).

If it is determined that the CW#0 is decoded successfully but the CW#1 is not, the eNB 20 determines whether it is necessary for the UE 10 to transmit a new packet in uplink (320). If it is necessary for the UE 10 to transmit a new packet at step 320, the eNB 20 determines the scheduling information for the retransmission of the CW#1 and the transmission of the new packet corresponding to the CW#0 (330). That is, since the CW#0 has been decoded successfully, the eNB 20 determines the scheduling information for the new packet transmission corresponding to the CW#0. Meanwhile, since the CW#1 has not been decoded successfully, the eNB 20 determines the scheduling information for retransmission of the CW#1. If it is determined that there is no need for the transmission of a new packet at step 320, the eNB 20 determines the scheduling information in consideration of only the retransmission of the CW#1. There can be various operation ways of the eNB 20 and UE 10 for the retransmission of the CW#1. However, since the operations of the eNB 20 and UE 10 do not influence to the operations proposed in the present invention, specific restrictions are not applied to those operations.

Next, the eNB 20 determines if it is necessary to change the MCS for retransmission of the CW#1 or if the precoder for use in the next transmission of the UE 10 (340). If it is determined that at least one of the MCS and precoder of the UE 10 should be changed at step 340, the eNB 20 generates PDCCH corresponding to the DCI format 0B and transmits the control information to the UE 10 (350). If it is determined that no change of the MCS and precoder of the UE 10 is necessary at step 340, the eNB 20 should transmit a new DCI format for scheduling both the initial transmission of the CW#0 and the retransmission of CW#1, the new DCI formation being same as the DCI format 0 in size. The new DCI formation considered in the present invention is referred to as DCI format 0C.

Here, it is necessary to explain the design of the DCI format 0C. The DCI format 0C is same as the DCI format 0 in size. The DCI format 0C should be designed to indicate one retransmission and one initial transmission and inform whether which one codeword of the CW#0 and CW#1 is decoded successfully. The DCI format 0C also should have the fields such as MCS, TPC command, and CQIR fields for the next initial transmission. In consideration of the aforementioned elements, the DCI format 0C as defined in table 3 is available.

TABLE 3

| Field | Bits |
|---|---|
| Differentiation flag | 1 |
| Retransmission indicator | 1 |
| Resource block assignment | ┌log₂\|N_{RB}^{UL}\|N_{RB}^{UL} + 1\|/2\|┐ |
| Modulation and coding scheme | 5 |
| New data indicator | 1 |
| TPC command | 2 |
| CW indicator | 1 |
| CQI request | 1 |
| Etc. | 2 |

The DCI format 0C proposed as shown in table 3 is same as the DCI format 0 of table 1 is size. Here, the bit corresponding to the FH field of the DCI formation 0 is used as a retransmission (ReTx) indicator field of the DCI format 0C, and one bit of the CSI field of the DCI format 0 is used as the codeword indicator (CW indicator) of the DCI format 0C. In this case, the ReTx indicator has a bit value for differentiating between the DCI format 0 and DCI format 0C such that the ReTx is set to 0 for indicating the DCI formation 0 of PDCCH and 1 for indicating the DCI format 0C of PDCCH. The CW indicator has a bit value indicating which codeword of the CW#0 and CW#1 is decoded successfully such that the CW indicator is set to 0 for indicating the successful decoding on the CW#0 and 1 for indicating the successful decoding on the CW#1. In this case, since the FH field is used as the ReTx indicator field and the one bit of the CSI field as CW indicator field, it is necessary to assume that the frequency hopping is not supported in the SU-MIMO mode and the UE 10 received the DCI format 0C sets the CS to the same value as that of the previous transmission.

Typically, the DCI format 0 has padding bits added for obtain the number of bits of the DCI format in downlink in addition to the fields listed in table 1, and it can be considered to use some of the padding bits as the ReTx indicator field of the DCI format 0C. In this case, the restrictive condition of the frequency hopping in SU-MIMO mode is not necessary. The CW indicator of the DCI format 0C can be set with a bit of the padding bits or a bit of the RBA field rather than a bit of the CSI indicator, and in case of using the RBA field, it should be assumed that the UE 10 received the DCI format 0C configures the frequency resource for transmission to be in identical with the previous transmission.

In order to perform scheduling of both the retransmission of CW#1 and the initial transmission of CW#0 with the PDCCH corresponding to the DCI format 0C, the eNB 20 toggles the NDI field (351). At step 351, the reason why the eNB 20 toggles the NDI can be for the UE to confirm the successful receipt of the DCI format 0C by using the NDI as virtual CRC. Another reason why the eNB 20 toggles the NDI is to differentiate the scheduling operation with DCI format 0C from operation of the eNB 20 and UE 10 such as retransmission-only scheduling with the NDI which is not toggled. At step 351, the eNB 20 sets the ReTx indicator and CW indicator to 1 and 0 respectively and transmits the DCI format 0C containing the scheduling information for initial transmission in PDCCH.

Meanwhile, if it is determined that the CW#0 decoding is failed but the CW#1 is decoded successfully at step 311, the eNB 20 determines whether it is necessary for the UE 10 to transmit a new packet (321). If it is determined that a new packet transmission is necessary at step 321, the eNB 20 determines the scheduling information for the retransmission of the CW#0 and the new packet transmission of the CW#1 (331). That is, the eNB 20 determines the scheduling information for the new packet transmission corresponding to the CW#1 due to the successful decoding on the CW#1. Meanwhile, the eNB 20 determines the scheduling information for retransmission corresponding to the CW#0 due to the decoding failure on the CW#0. If it is determined that no new packet transmission is necessary at step 321, the eNB 20 determines the scheduling information in consideration of only the retransmission of CW#0. There can be various ways of operations of the eNB 20 and UE 10 for retransmission of CW#0. However, since the operations of the eNB 20 and UE 10 do not influence to the operations proposed in the present invention, specific restrictions are not applied to those operations.

Next, the eNB 20 determines if it is necessary to change the MCS for retransmission of the CW#1 or if the precoder for use in the next transmission of the UE 10 (341). If it is determined that no change of the MCS and precoder of the UE 10 is necessary at step 341, the eNB 20 generates PDCCH corresponding to the DCI format 0C and transmits the control information to the UE 10 (352). At this time, the eNB 20 configures the DCI format 0C in similar manner as at step 351. In case of scheduling the initial transmission of CW#1 and retransmission of CW#0, however, the eNB 20 sets the CW indicator to 1 but not 0. If it is determined that at least one of the MCS or the precoder of the UE 10 should be changed at step 341, the eNB 20 generates the PDCCH corresponding to the DCI format 0B and transmits the control information to the UE 10 (353).

Meanwhile, if it is determined that both the two codewords are decoded successfully at steps 310 and 311, the eNB 20 determines whether it is necessary for the UE 10 to transmit a new packet in uplink (322). If it is determined that a new packet transmission is necessary at step 322, the eNB determines whether it is necessary for the UE 10 to operate in fallback mode (332). If it is necessary for the UE 10 to operate in fallback mode at step 332, the eNB 20 determines the scheduling information for a new packet transmission of at least one of CW#0 and CW#1 (342). If it is not necessary for the UE 10 to operate in fallback mode at step 332, basic eNB operations necessary for the new transmission in SU-MIMO occur and this is determined in separation from the situation considered in the present invention. Next, the eNB 20 generates PDCCH corresponding to DCI format 0 and transmits the control information to the UE 10 (354). At this time, the eNB 20 has to toggle the NDI field. Next, the eNB 20 sets the ReTx indicator to 0 and transmits the DCI format 0 containing the scheduling information for initial transmission in PDCCH. Here, in case that it is necessary to perform scheduling only one codeword to the UE 10 with the DCI format 0, the eNB sets the ReTx indicator to 0 and other fields to the values of the DCI format 0 as shown in table 1.

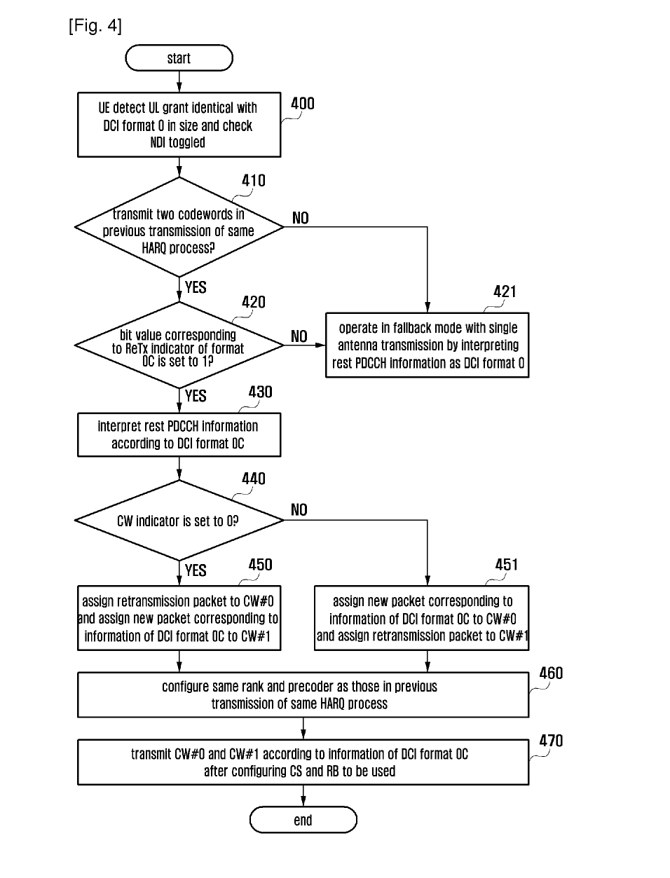

FIG. 4 is a flowchart illustrating operations of the UE according to the first embodiment of the present invention.

In the embodiment depicted in FIG. 4, the UE 10 detects the control information having the same size as the DCI format 0 on PDCCH and checks the NDI field toggled (400). Next, the UE 10 determines whether the previous transmission in the same HARQ process has carried two codewords (410). If it is determined that the previous transmission has carried one codeword at step 410, the UE 10 interprets the rest PDCCH, except for the ReTx indicator, as the DCI format 0 and operates as an LTE UE (421). Otherwise, if it is determined that the previous transmission has carried two codewords at step 410, the UE 10 determines whether the bit value of the ReTx indicator is set to 1 (420). If the bit value of the ReTx indicator is set to 0 at step 420, the UE 10 interprets the rest PDCCH as the DCI format 0 and thus operates as an LTE UE (421).

Otherwise, it is determined that the bit value of the ReTx indicator is set to 1 at step 420, the UE 10 interprets the rest PDCCH information as DCI format 0C (430). Next, the UE 10 determines whether the CW indicator in the DCI format 0C is set to 1 (440). If it is determined that the CW indicator in the DCI format 0C is set to 1, the UE 10 assigns the retransmission packet to the CW#0 and assigns the new packet generated according to the DCI format 0C to the CW#0 (450). If it is determined that the CW indicator is set to 0 at step 440, the UE 10 assigns the retransmission packet to the CW#1 and the new packet generated according to the DCI format 0C information is assigned to the CW#0 (451).

Next, the UE 10 configures the same rank and precoder as those used in the previous transmission of the same HARQ process (460). Next, the UE 10 configures the CS or RB to be used and transmits the CW#0 and CW#1 to the eNB 20 according to the DCI format 0C information (470). In this case, the CS or RB is configured depending on the field of the DCI format 0 to which the CW indicator field corresponds in the design of the DCI format 0C. For example, if the CW indicator field of the DCI format 0C corresponds to the CSI field of the DCI format 0, the UE 10 configures the same CS as that used in the previous transmission. Otherwise, if the CW indicator field of the DCI format 0C corresponds to the RBA field of the DCI format 0, the UE 10 configures the same RB as that used in the previous transmission. Otherwise, if the CW indicator field of the DCI format 0C corresponds to the padding bit of the DCI format 0, the UE 10 configures the CSI field and RBA field for the same original purpose as in the DCI format 0. Also, the ReTx indicator of the DCI format 0C can be designed to correspond to the one of the FH field or padding bits of the DCI format 0. If the FH field is used for ReTx indicator, it is necessary to assume that the frequency hopping is supported in SU-MIMO mode. If a padding bit is used for the ReTx indicator, the padding bit cannot be used for the CW indicator.

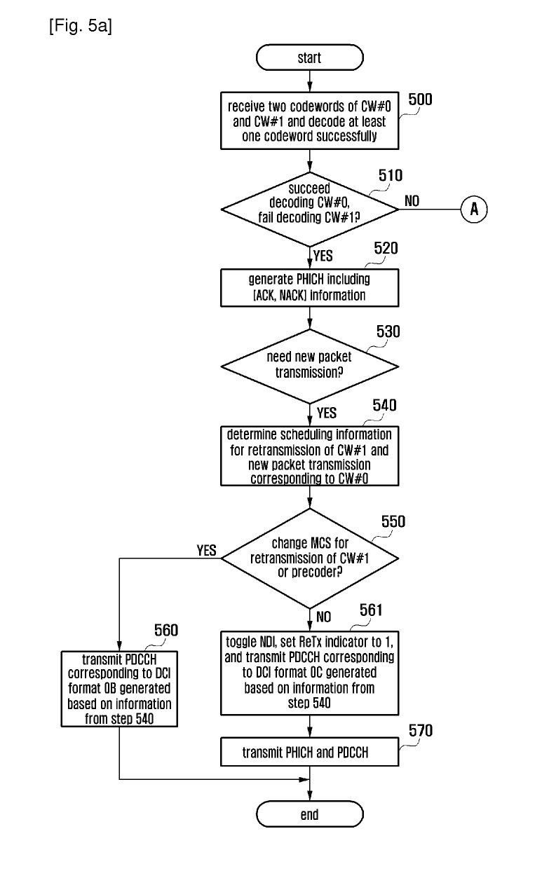

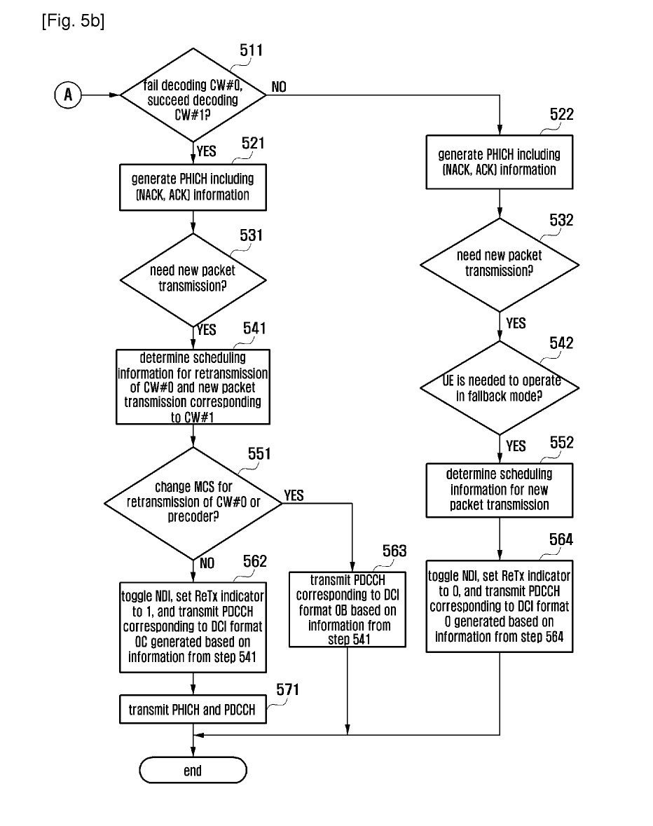

FIGS. 5A and 5B are flowcharts illustrating operations of the eNB according to the second embodiment of the present invention. The second embodiment differs from the first embodiment in that the eNB determines arrangement of the retransmission and initial transmission with PHICH information rather than separately configuring the CW indicator in the DCI format 0C.

In this embodiment depicted in FIGS. 5A and 5B, the eNB 20 first decodes at least one of the two codewords, i.e. CW#0 and CW#1, received from the UE 10 successfully (500). Next, the eNB 20 determines which codeword is decoded successfully among the CW#0 and CW#1 (510 and 511).

If it is determined that the CW#0 is decoded successfully but the CW#1 is not, the eNB 20 generates response information, i.e. PHICH including (ACK, NACK) information (520). Next, the eNB 20 determines whether it is necessary for the UE 10 to transmit a new packet in uplink (530). If it is necessary for the UE 10 to transmit a new packet at step 530, the UE 20 determines the scheduling information on the retransmission of CW#1 and the new initial packet transmission for the CW#0 (540). That is, since the CW#0 has been decoded successfully, the eNB 20 determines the scheduling information for the new packet transmission corresponding to the CW#0. Meanwhile, since the CW#1 has not been decoded successfully, the eNB 20 determines the scheduling information for retransmission of the CW#1. If it is determined that there is no need for the transmission of a new packet at step 530, the eNB determines scheduling information in consideration of only the retransmission of the CW#1. There can be various operation ways of the eNB 20 and UE 10 for the retransmission of the CW#1. However, since the operations of the eNB 20 and UE 10 do not influence to the operations proposed in the present invention, specific restrictions are not applied to those operations.

Next, the eNB 20 determines if it is necessary to change the MCS for retransmission of the CW#1 or if the precoder for use in the next transmission of the UE 10 (550). If it is determined that at least one of the MCS and precoder of the UE 10 should be changed at step 550, the eNB 20 generates PDCCH corresponding to the DCI format 0B and transmits the control information to the UE 10 (560). If it is determined that no change of the MCS and precoder of the UE 10 is necessary at step 550, the eNB 20 toggles the NDI (561). The reason why the eNB 20 toggles the NDI is can be for the UE to confirm the successful receipt of the DCI format 0C by using the NDI as virtual CRC. Also, the reason why the eNB 20 toggles the NDI is to differentiate the scheduling operation with DCI format 0C from operation of the eNB 20 and UE 10 such as retransmission-only scheduling with the NDI which is not toggled. At this time, the eNB 20 sets the ReTx indicator to 1 and transmits the DCI format 0C containing the scheduling information for the initial transmission in PDCCH. The eNB 20 also transmits the PHICH such that the UE 10 to recognize the position of the re-transmission codeword.

Meanwhile, if it is determined that the CW#0 decoding is failed but the CW#1 is decoded successfully at step 511, the eNB 20 generates PHICH including the response information, i.e. (NACK, ACK) information (521). Next, the eNB 20 determines whether it is necessary for the UE 10 to transmit a new packet (531). If it is determined that a new packet transmission is necessary at step 531, the eNB determines the scheduling information for the new packet transmission for the retransmission of the CW#0 and the new transmission of the CW#1 (541). That is, the eNB 20 determines the scheduling information for the new packet transmission corresponding to the CW#1 due to the successful decoding on the CW#1. Meanwhile, the eNB 20 determines the scheduling information for retransmission corresponding to the CW#0 due to the decoding failure on the CW#0. If it is determined that no new packet transmission is necessary at step 5311, the eNB 20 determines the scheduling information in consideration of only the retransmission of CW#0. There can be various ways of operations of the eNB 20 and UE 10 for retransmission of CW#0. However, since the operations of the eNB 20 and UE 10 do not influence to the operations proposed in the present invention, specific restrictions are not applied to those operations.

Next, the eNB determines if it is necessary to change the MCS for retransmission of the CW#1 or if the precoder for use in the next transmission of the UE 10 (551). If it is determined that at least one of the MCS or the precoder of the UE 10 should be changed at step 551, the eNB 20 generates the PDCCH corresponding to the DCI format 0B and transmits the control information to the UE 10 (563). If it is determined that no change of the MCS and precoder of the UE 10 is necessary at step 551, the eNB 20 toggles the NDI (562). The reason why the eNB 20 toggles the NDI is can be for the UE to confirm the successful receipt of the DCI format 0C by using the NDI as virtual CRC. Also, the reason why the eNB 20 toggles the NDI is to differentiate the scheduling operation with DCI format 0C from operation of the eNB 20 and UE 10 such as retransmission-only scheduling with the NDI which is not toggled. At this time, the eNB 20 sets the ReTx indicator to 1 and transmits the DCI format 0C containing the scheduling information for the initial transmission in PDCCH. The eNB 20 also transmits the PHICH such that the UE 10 to recognize the position of the retransmission codeword.

Meanwhile, if it is determined that both the two codewords are decoded successfully at steps 510 and 511, the eNB generates PHICH including the response information, i.e. ACK/NACK information (522). Next, the eNB 20 determines whether it is necessary for the UE 10 to operate in fallback mode (542). If it is necessary for the UE 10 to operate in fallback mode at step 542, the eNB 20 determines the scheduling information for a new packet transmission of at least one of CW#0 and CW#1 (552).). If it is not necessary for the UE 10 to operate in fallback mode at step 542, basic eNB operations necessary for the new transmission in SU-MIMO occur and this is determined in separation from the situation considered in the present invention. Next, the eNB 20 generates PDCCH corresponding to DCI format 0 and transmits the control information to the UE 10 (564). At this time, the eNB 20 has to toggle the NDI field. Next, the eNB 20 sets the ReTx indicator to 0 and transmits the DCI format 0 containing the scheduling information for initial transmission through PDCCH. Here, in case that it is necessary to perform scheduling only one codeword to the UE 10 with the DCI format 0, the eNB sets the ReTx indicator to 0 and other fields to the values of the DCI format 0 as shown in table 1.

Since a separate CW indicator is not taken into account in this embodiment, there is no need of the CW indicator field in the DCI format 0C proposed as shown in table 3. Here, the CSI field of the DCI format 0C can be used for the same purpose as that of the DCI format 0. Since the FH field is used as the ReTx indicator, it is necessary to assume that the frequency hopping is not supported in SU-MIMO mode. If a padding bit is used as the ReTx indicator for the DCI format 0C, there is no need of the restrictive condition of frequency hopping in SU-MIMO mode.

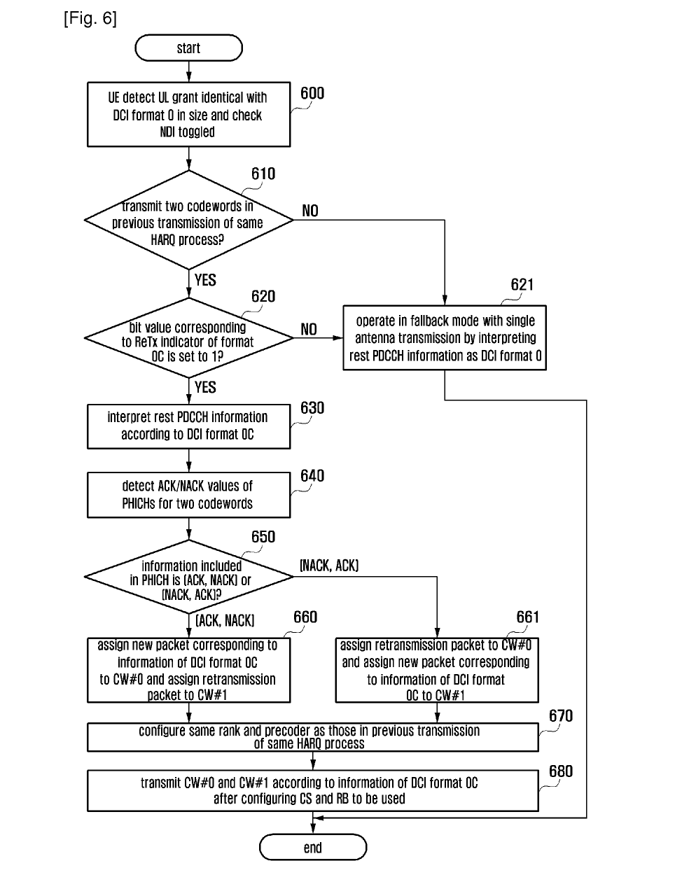

FIG. 6 is a flowchart illustrating operations of the UE according to the second embodiment of the present invention.

In this embodiment depicted in FIG. 6, the UE 10 detects the control information having the same size as the DCI format 0 through the PDCCH and checks the NDI field toggled (600). Next, the UE 10 determines whether the previous transmission in the same HARQ process has carried two codewords (610). If it is determined that the previous transmission has carried one codeword at step 610, the UE 10 interprets the rest PDCCH, except for the ReTx indicator, as the DCI format 0 and operates as an LTE UE (621). Otherwise, if it is determined that the previous transmission has carried two codewords at step 610, the UE 10 determines whether the bit value of the ReTx indicator is set to 1 (620). If the bit value of the ReTx indicator is set to 0 at step 620, the UE 10 interprets the rest PDCCH as the DCI format 0 and thus operates as an LTE UE (621).

Otherwise, it is determined that the bit value of the ReTx indicator is set to 1 at step 620, the UE 10 interprets the rest PDCCH information as DCI format 0C (630). Next, the UE 10 extracts the response information for the two codewords, i.e. ACK/NACK values, from the PHICH (640). After extracting the response information, the UE 10 determines whether the response information has a value of (ACK, NACK) or (NACK, ACK) (650). If it is determined that the response information has a value of (NACK, ACK), the UE 10 assigns the retransmission packet to the CW#0 and the new packet generated according to the DCI format 0C to the CW#1 (661). Otherwise, if it is determined that the response information has a value of (ACK, NACK), the UE 10 assigns the retransmission packet to the CW#1 and the new packet generated according to the DCI format 0C to the CW#0 (660).

Next, the UE 10 configures the same rank and precoder as those used in the previous transmission of the same HARQ process (670). Next, the UE 10 configures the CS or RB to be used and transmits the CW#0 and CW#1 to the eNB 20 according to the DCI format 0C information (680). As aforementioned, the ReTx indicator of the DCI format 0C can be designed to correspond to one of the FH field or a padding bit of the DCI format 0. In case of using the FH field for the ReTx indicator, it is necessary to assume that the frequency hopping is not supported in SU-MIMO mode.

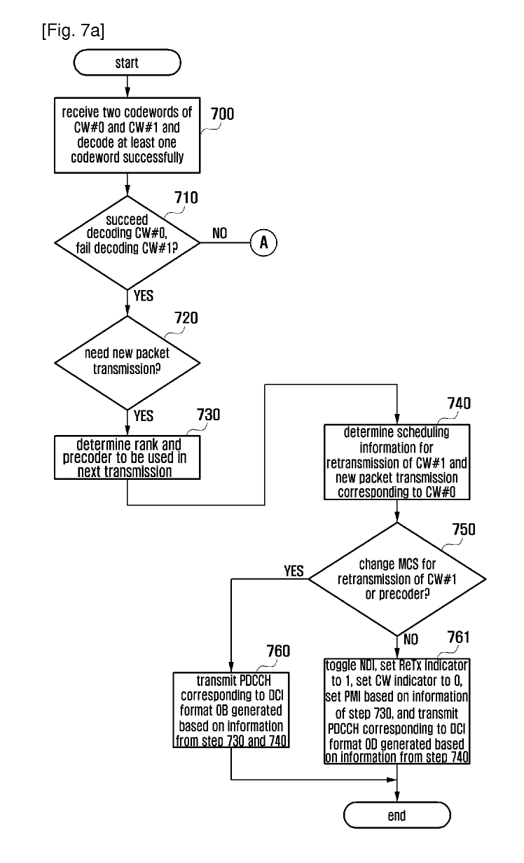

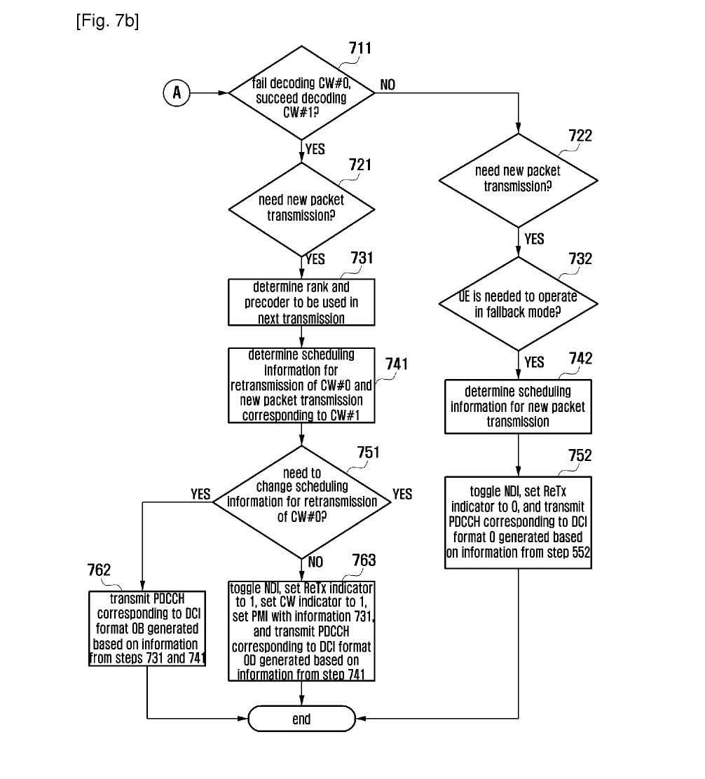

FIGS. 7A and 7B are flowcharts illustrating operations of the eNB according to the third embodiment of the present invention. The third embodiment differs from the above-described embodiments in that the PMI information is used for the eNB to change the precoder to be used in the next transmission.

In this embodiment depicted in FIGS. 7A and 7B, the eNB 20 first decodes at least one of the two codewords, i.e. CW#0 and CW#1, received from the UE 10 successfully (700). Next, the eNB 20 determines which codeword is decoded successfully among the CW#0 and CW#1 (710 and 711).

If it is determined that the CW#0 is decoded successfully but the CW#1 is not, the eNB 20 determines whether it is necessary for the UE 10 to transmit a new packet in uplink (720). If it is necessary for the UE 10 to transmit a new packet at step 720, the eNB 20 determines the rank and precoder to be used in the next transmission (730). Next, the eNB determines the scheduling information for retransmission of the CW#1 and new packet transmission for the CW#0 (740). The eNB 20 determines the scheduling information for retransmission corresponding to the CW#1 due to the decoding failure of the CW#1. If it is not necessary for the UE 10 to transmit a new packet at step 720, the eNB determines the scheduling information in consideration of only the retransmission of the CW#1. There can be various operation ways of the eNB 20 and UE 10 for the retransmission of the CW#1. However, since the operations of the eNB 20 and UE 10 do not influence to the operations proposed in the present invention, specific restrictions are not applied to those operations.

Next, the eNB 20 determines if it is necessary for the UE 10 to change the scheduling information, such as MCS for retransmission of the CW#1, in the scheduling information (750). If it is necessary for the UE 10 to change the scheduling information such as MCS for retransmission at step 750, the eNB 20 generates PDCCH corresponding to the DCI format 0B and transmits the control information to the UE 10 (760). Otherwise, if it is not necessary for the UE 10 to change the scheduling information such as MCS, the eNB 20 should transmit a new DCI format that is capable of scheduling of both the initial transmission of the CW#0 and the retransmission of the CW#1 to the UE 10 and carrying the information on the precoder (761). The new DCI format proposed in the present invention to carry the information on the precoder is referred to as DCI format OD.

Here, it is necessary to explain the design of the DCI format OD. The DCI format OD has to have the information on the precoder to be used in the next transmission in addition to the information contained in the DCI format 0C. In consideration of this issue, the DCI format OD can be designed as shown in table 4.

TABLE 4

| Field | Bits |
|---|---|
| Differentiation flag | 1 |
| Retransmission indicator | 1 |
| Precoding matrix indicator | 5 |
| Modulation and coding scheme | 5 |
| New data indicator | 1 |
| TPC command | 2 |
| CW indicator | 1 |
| CQI request | 1 |
| Etc. | ┌log₂\|N_{RB}^{UL}\|N_{RB}^{UL} + 1\|/2\|┐ − 3 |

The DCI format OD proposed as shown in table 4 is same as the DCI format 0 of table 1 in size. Here, the bit corresponding to the FH field of the DCI formation 0 is used as a retransmission (ReTx) indicator field of the DCI format OD, one bit of the CSI field of the DCI format 0 is used as the codeword indicator (CW indicator) of the DCI format OD, and the RBA field is used as the PMI for indicating the precoder. In this case, the ReTx indicator has a bit value for differentiating between the DCI format 0 and DCI format OD such that the ReTx is set to 0 for indicating the DCI formation 0 of PDCCH and 1 for indicating the DCI format OD of PDCCH. The CW indicator has a bit value indicating which codeword of the CW#0 and CW#1 is decoded successfully such that the CW indicator is set to 0 for indicating the successful decoding on the CW#0 and 1 for indicating the successful decoding on the CW#1. Also, the PMI is the field for indicating the precoder to be used in the next transmission by differentiating among up to 32 precoders with 5 bits. In this case, since the FH field is used as the ReTx indicator field, one bit of the CSI field as CW indicator field, and five bits of the RBA field as the PMI; it is necessary to assume that the frequency hopping is not supported in the SU-MIMO mode and the UE 10 received the DCI format OD sets the CS and the frequency resource to be used to the same values as those of the previous transmission.

Typically, the DCI format 0 has padding bits added for obtain the number of bits of the DCI format in downlink in addition to the fields listed in table 1, and it can be considered to use some of these bits as the ReTx indicator field of the DCI format OD. In this case, the restrictive condition of the frequency hopping in SU-MIMO mode is not necessary. The CW indicator of the DCI format OD also can be set with a bit of the padding bits rather than a bit of the CS indicator.

In order to perform scheduling of both the retransmission of CW#1 and the initial transmission of CW#0 with the PDCCH corresponding to the DCI format OD, the eNB 20 has to toggle the NDI field (761). At step 761, the reason why the eNB 20 toggles the NDI can be for the UE to confirm the successful receipt of the DCI format OD by using the NDI as virtual CRC. Another reason why the eNB 20 toggles the NDI is to differentiate the scheduling operation with DCI format OD from operation of the eNB 20 and UE 10 such as retransmission-only scheduling with the NDI which is not toggled. At step 761, the eNB 20 sets the ReTx indicator and CW indicator to 1 and 0 respectively and transmits the DCI format OD containing the scheduling information for initial transmission in PDCCH.

Meanwhile, if it is determined that the CW#0 decoding is failed but the CW#1 is decoded successfully at step 711, the eNB 20 determines whether it is necessary for the UE 10 to transmit a new packet (721). If it is determined that a new packet transmission is necessary at step 721, the eNB 20 determines the rank and precoder to be used in the next transmission (731). Next, the eNB 20 determines the scheduling information for the retransmission the CW#0 and the new packet transmission for the CW#1 (741). That is, the eNB 20 determines the scheduling information for the new packet transmission corresponding to the CW#1 due to the successful decoding on the CW#1. Meanwhile, the eNB 20 determines the scheduling information for retransmission corresponding to the CW#0 due to the decoding failure on the CW#0. If it is determined that a new packet transmission is not necessary at step 721, the eNB 20 determines the scheduling information in consideration of only the retransmission of CW#0. There can be various ways of operations of the eNB 20 and UE 10 for retransmission of CW#0. However, since the operations of the eNB 20 and UE 10 do not influence to the operations proposed in the present invention, specific restrictions are not applied to those operations.

Next, the eNB 20 determines if it is necessary to change the MCS for retransmission of the CW#0 in the scheduling (751). If it is not necessary to change the scheduling information, the eNB 20 generates PDCCH corresponding to the DCI format OD and transmits the control information to the UE 10 (763). At this time, the eNB 20 configures the DCI format OD in similar manner as at step 761. In case of scheduling the initial transmission of CW#1 and retransmission of CW#0, however, the eNB 20 sets the CW indicator to 1 but not 0. If it is necessary to change the scheduling information, the eNB 20 generates PDCCH corresponding to the DCI format 0B and transmits the control information to the UE 10 (762).

Meanwhile, if it is determined that both the two codewords are decoded successfully at steps 710 and 711, the eNB 20 determines whether it is necessary for the UE 10 to transmit a new packet in uplink (722). If it is determined that a new packet transmission is necessary at step 722, the eNB determines whether it is necessary for the UE 10 to operate in fallback mode (732). If it is necessary for the UE 10 to operate in fallback mode at step 732, the eNB 20 determines the scheduling information for a new packet transmission of at least one of CW#0 and CW#1 (742). If it is not necessary for the UE 10 to operate in fallback mode at step 732, basic eNB 20 operations necessary for the new transmission in SU-MIMO occur and this is determined in separation from the situation considered in the present invention. Next, the eNB 20 generates PDCCH corresponding to DCI format 0 and transmits the control information to the UE 10 (752). At this time, the eNB 20 has to toggle the NDI field. Next, the eNB 20 sets the ReTx indicator to 0 and transmits the DCI format 0 containing the scheduling information for initial transmission in PDCCH. Here, in case that it is necessary to perform scheduling only one codeword to the UE 10 with the DCI format 0, the eNB sets the ReTx indicator to 0 and other fields to the values of the DCI format 0 as shown in table 1.

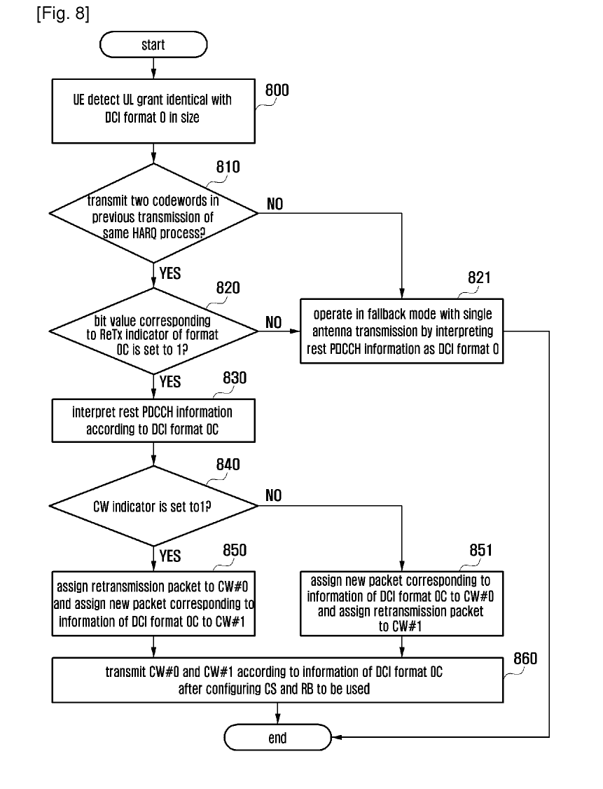

FIG. 8 is a flowchart illustrating operations of the UE according to the third embodiment of the present invention.

In this embodiment depicted in FIG. 8, the UE 10 first detects the control information having the same size as the DCI format 0 on PDCCH (800). Next, the UE 10 determines whether the previous transmission in the same HARQ process has carried two codewords (810). If it is determined that the previous transmission has carried one codeword at step 810, the UE 10 interprets the rest PDCCH, except for the ReTx indicator, as the DCI format 0 and operates as an LTE UE (821). Otherwise, if it is determined that the previous transmission has carried two codewords at step 810, the UE 10 determines whether the bit value of the ReTx indicator is set to 1 (820). If the bit value of the ReTx indicator is set to 0 at step 820, the UE 10 interprets the rest PDCCH as the DCI format 0 and thus operates as an LTE UE (821).

Otherwise, it is determined that the bit value of the ReTx indicator is set to 1 at step 820, the UE 10 interprets the rest PDCCH information as DCI format OD (830). Next, the UE 10 determines whether the CW indicator in the DCI format 0C is set to 1 (840). If it is determined that the CW indicator in the DCI format OD is set to 1, the UE 10 assigns the retransmission packet to the CW#0 and assigns the new packet generated according to the DCI format 0C to the CW#0 (850). If it is determined that the CW indicator is set to 0 at step 840, the UE 10 assigns the retransmission packet to the CW#1 and the new packet generated according to the DCI format 0C information is assigned to the CW#0 (851).

Next, the UE 10 configures the CS or RB to be used and transmits the CW#0 and CW#1 to the eNB 20 according to the DCI format OD information (860). In this case, the CS or RB is configured depending on the field of the DCI format 0 to which the CW indicator field corresponds in the design of the DCI format OD. For example, if the CW indicator field of the DCI format OD corresponds to the CSI field of the DCI format 0, the UE 10 configures the same CS as that used in the previous transmission. Otherwise, if the CW indicator field of the DCI format OD corresponds to a padding bit the DCI format 0, the UE 10 uses the CSI field for the same original purpose in the DCI format 0. Since the PMI field of the DCI format OD is designed to correspond to the RBA field of the DCI format, the RB is configured to the same as in the previous transmission. Furthermore, the ReTx indicator of the DCI format OD can be designed to correspond to one of the FH field and a padding bit of the DCI format 0. In case of using the FH for the ReTx indicator, it is necessary to assume that the frequency hopping is not supported in SU-MIMO mode. If a padding bit is used for the ReTx indicator, the padding bit cannot be used for the CW indicator.

According to the present invention, when two codewords are assigned to a UE using multiple transmit antenna in an LTE-A uplink and one of the codewords is decoded successfully but the other is not, the proposed method is capable of scheduling of the retransmission and initial transmission of the UE simultaneously with a small number of bits without increase of PDCCH decoding complexity. That is, the present invention is capable of decreasing both the PDCCH decoding complexity of the UE in HARQ process and resource amount necessary for control signal transmission.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

1. A retransmission control method of a base station in a wireless communication system, comprising:
decoding two codewords received;
determining, when one of the two codewords is decoded successfully but the other is not, scheduling information for initial transmission corresponding to the successfully decoded codeword and retransmission corresponding to the failed codeword; and
transmitting control information generated according to a DCI format having a retransmission indicator for requesting for retransmission.

2. The retransmission control method of a claim 1, further comprising:
determining, when the codewords are decoded successfully, the scheduling information for the initial transmission of one of the two codewords; and
transmitting the control signal generated according to a DCI format 0 configured with a predetermined number of bits,
where the DCI format is identical with the DCI format 0 in number of bits.

3. The retransmission control method of claim 2, wherein the DCI format comprises a codeword indicator for identifying the codeword decoded successfully.

4. The retransmission control method of claim 2, wherein transmitting comprises sending PHICH including a NACK signal corresponding to the failed codeword and an ACK signal corresponding to the codeword decoded successfully.

5. A retransmission control method of a terminal in a wireless communication system, comprising:
determining, when a control signal is received in a DCI format, whether the control signal is a response to two codewords;
determining, when the control signal is a response to two codewords, whether the DCI format includes a retransmission indicator; and
performing, when the DCI format includes a retransmission indicator, initial transmission corresponding to one of the tow codewords and retransmission corresponding to the other.

6. The transmission control method of claim 5, further comprising performing, when the control signal is a response to a single codeword or when the DCI format does not include the retransmission indicator, initial transmission corresponding to the single codeword by interpreting the control signal as a DCI format 0 configured with a predetermined number of bits, wherein the DCI format is identical with the DCI format 0 in number of bits.

7. The transmission control method of claim 6, wherein the DCI format comprises a codeword indicator for identifying the codeword for initial transmission among the tow codewords, and performing comprises determining whether to perform retransmission of each codeword according to the codeword indicator.

8. The transmission control method of claim 6, wherein performing comprises determining, when a NACK signal or an ACK signal is received on PHICH, whether to perform retransmission of each codeword according to the NACK signal.

9. A receiver of a base station in a wireless communication system, comprising:
a decoder which decodes two codewords received; and
a control signal generator which determining, when one of the two codewords is decoded successfully but the other is not, scheduling information for initial transmission corresponding to the successfully decoded codeword and retransmission corresponding to the failed codeword and transmits control information generated according to a DCI format having a retransmission indicator for requesting for retransmission.

10. The receiver of claim 9, wherein the control signal generator determines, when the codewords are decoded successfully, the scheduling information for the initial transmission of one of the two codewords and transmits the control signal generated according to a DCI format 0 configured with a predetermined number of bits, wherein the DCI format is identical with the DCI format 0 in number of bits.

11. The receiver of claim 10, wherein the DCI format comprises a codeword indicator for identifying the codeword decoded successfully.

12. The receiver of claim 10, wherein the control signal generator transmits PHICH including a NACK signal corresponding to the failed codeword and an ACK signal corresponding to the codeword decoded successfully.

13. A transmitter of a terminal in a wireless communication system, comprises:
a control signal detector which determines, when a control signal is received in a DCI format, whether the control signal is a response to two codewords and determines, when the control signal is a response to two codewords, whether the DCI format includes a retransmission indicator; and
a retransmission controller which performs, when the DCI format includes a retransmission indicator, initial transmission corresponding to one of the tow codewords and retransmission corresponding to the other.

14. The transmitter of claim 13, wherein the retransmission controller performs, when the control signal is a response to a single codeword or when the DCI format does not include the retransmission indicator, initial transmission corresponding to the single codeword by interpreting the control signal as a DCI format 0 configured with a predetermined number of bits, wherein the DCI format is identical with the DCI format 0 in number of bits.

15. The transmitter of claim 14, wherein the DCI format comprises a codeword indicator for identifying the codeword for initial transmission among the tow codewords, and the retransmission controller determines whether to perform retransmission of each codeword according to the codeword indicator.
